(19) United States
(12) Patent Application Publication
(10) Pub. No.: US 2006/0047604 A1
(43) Pub. Date: Mar. 2, 2006

(54) Methods and apparatus providing portable application and data

(76) Inventors: Oded Schlomo Kraft-Oz, Haifa (IL); Mishel Shuraki, Hadera (IL)

Correspondence Address: Dean D. Small;Armstrong Teasdale LLP, Suite 2600, One Metropolitan Square, St. Louis, MO, 63102, US

(21) Appl. No.: 10/930,992

(22) Filed: Aug. 31, 2004

(51) Int. Cl. G06F 17/60

(52) U.S. Cl. 705/59

(57) ABSTRACT

A method and apparatus for executing an application program resident on a portable memory device is provided. The method includes providing a portable memory device having at least one application program stored thereon, determining whether a valid license corresponds to the application program, the application license residing, at least partially, on the portable memory device, and executing the application program from the portable memory device using a host platform processor if the presence of a valid license is determined.

### BACKGROUND OF THE INVENTION

This invention relates generally to memory devices, and more particularly to flash memory devices for operating program applications.

At least some known software requires a user input, such as a serial number, when the software, such as an operating system or application program is installed in a personal computer to establish a valid license. For example, during installation of an operating system recorded on a CD-ROM medium, the user may be prompted to input a CD key unique to the CD-ROM medium. A serial number such as a CD key is typically provided in a manual or license agreement in the software distribution package. The user may input the serial number using a keyboard. The operating system or application program is loaded onto memory media in the personal computer after input of a valid CD key and enabled for use on that machine. In some instances, the user still may remove the CD-ROM medium and using the CD key may install the operating system or application program on a plurality of other personal computers exceeding the range permitted by the license.

At least some known users, such as physicians, often need to be able to make a diagnosis of a patient using various types of data, at least some of which may be in an electronic form, for example, medical diagnostic image files. The data may be viewed or manipulated by a specialized application program. The user may want to access the data and the application in a medical office of the user, at the user's home, or at an office of a colleague for consultation with the colleague regarding the data. Some known methods provide portability of the data and include a laptop computer, a plurality of substantially similarly configured workstations, a network, and various memory media, such as a read/write compact disc. A laptop may not provide the degree of portability demanded by the user in some cases, a plurality of similarly configured workstations also requires the additional expense of the workstations and a software license to run the application program at multiple locations, the network may not extend to all locations the user may desire to use the data, and using available memory media may not provide the data transfer rates necessary to operate the application program and data, and also may not provide adequate intellectual property protection for the application program developer.

### BRIEF DESCRIPTION OF THE INVENTION

In one embodiment, a method of executing an application program residing on a portable memory device is provided. The method includes providing a portable memory device having at least one application program stored thereon, determining whether a valid license corresponds to the application program, the application license residing, at least partially, on the portable memory device, and executing the application program from the portable memory device using a host platform processor if the presence of a valid license is determined.

In another embodiment, a portable memory device is provided. The portable memory device includes a data connector configured to couple to a host computer, an application program memory portion coupled in communication with said data connector, said application program memory portion configured to store an application program executable from said application program memory portion, a data memory portion coupled to said data connector, said data memory portion configured to store data for access by at least one of said application program and a program executing on the host computer, and a license memory portion for storing software license information.

### BRIEF DESCRIPTION OF THE DRAWINGS

FIG. 1 is a schematic block diagram of an exemplary flash memory device in accordance with one embodiment of the present invention; and

FIG. 2 is a flowchart of an exemplary method of operating the flash memory device shown in FIG. 1.

### DETAILED DESCRIPTION OF THE INVENTION

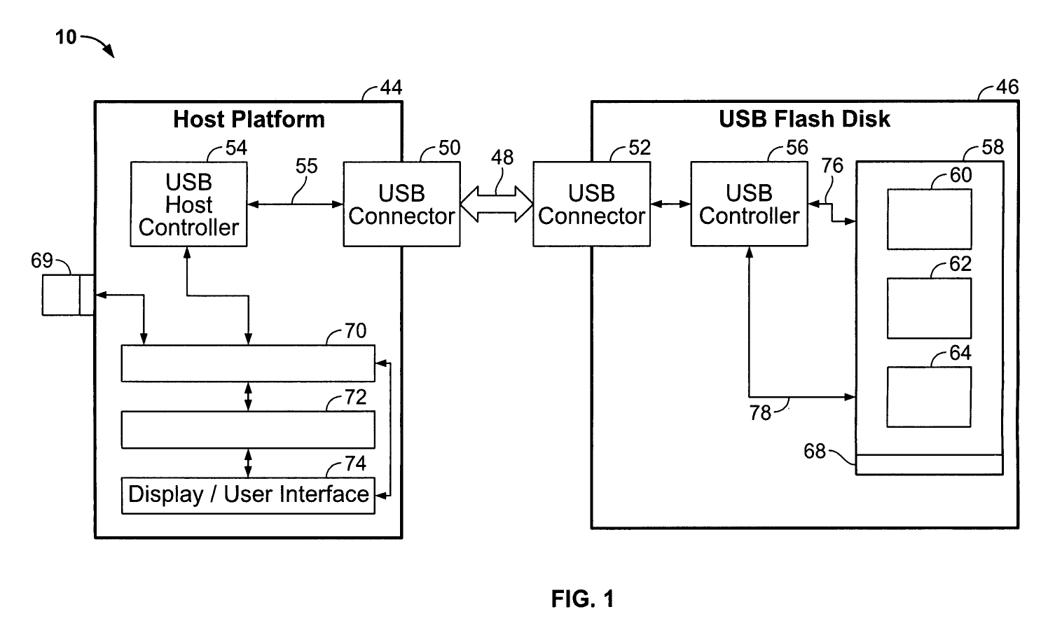

FIG. 1 is a schematic block diagram of an exemplary flash memory device 10 that is couplable to a host platform 44, such as, but, not limited to, a personal computer, laptop computer, workstation, and personal digital assistant (PDA). In the exemplary embodiment, host platform 44 interfaces with flash memory device 10 in a portable memory configuration, such as a removable solid state hard drive. In an alternative embodiment, host platform 44 interfaces with flash memory device 10 as a non-volatile storage space. Flash memory device 10 may be embodied, for example, in a plug-and-play portable storage device that uses flash memory. Flash memory 10 also may be provided as, for example, a keychain drive, a USB drive, a flash drive, or a disk-on-key. When a user couples flash memory device 10 to host platform 44, the operating system of host platform 44 may recognize flash memory device 10 as a removable drive, but does not require rebooting and is not platform dependent. Flash memory device 10 may include password protection. Flash memory device 10 may operate in cooperation with drivers resident on host platform 44. Such drivers may be required to support older host platform 44 systems that do not have a compatible port, such as a USB port. In one embodiment, host platform 44 is couplable to flash memory device 10 through a USB cable 48 and/or direct connection. Host platform 44 couples to USB cable 48 through a USB host connector 50, while flash memory device 10 connects to USB cable 48 through a USB flash device connector 52. Host platform 44 includes a USB host controller 54 for controlling and managing USB transfers on a USB bus 55.

Flash memory device 10 includes a USB flash device controller 56 for controlling operation and communication of flash memory device 10 including between flash memory device 10 and USB bus 55 via USB flash device connector 52 and in at least one flash memory module 58. Flash memory module 58 may include an array of flash memory modules 58 in which data may be stored. The at least one flash memory module 58 may include a plurality of memory areas for storing predetermined functional code and/or data. The memory areas may be logically segmented memory portions or may be separate physical memory storage units. In one exemplary embodiment, flash memory module 58 includes an application program area 60, an application data area 62, and an application license area 64. Flash memory module 58 also may include a hard-coded, for example, unalterable, serial number area 68 that includes a unique identifier for each flash memory device 10. Serial number area 68 may be located remote from flash memory module 58, for example, on a separate chip or device, such as a dongle 69. As used herein, “dongle” refers to a mechanical device that may include an electronic circuit, used to prevent unlicensed use of the application program. A dongle may be configured as a small connector plug that is couplable to a socket on host platform 44, such as a parallel port. Without the dongle present, the application program will not run. Host platform 44, in one embodiment, includes a processor 70 coupled to USB host controller 54 and a memory 72. Memory 72 may include various forms of volatile and non-volatile memory, such as RAM, ROM, hard drives, CD and DVD ROM drives, and processor memory. A display and user interface 74 allows, for example, user command and data input and display of data.

During operation, when flash memory device 10 is coupled to USB connector 50 and host platform 44, the coupling of the connected flash memory device 10 is detected and a configuration process for the USB connected flash memory device 10, known as device enumeration, is initiated. The enumeration process assigns a unique USB address to the connected flash memory device 10, queries the connected flash memory device 10 regarding requirements and capabilities of flash memory device 10, writes data, for example, configuration information, accessed from flash memory device 10 into an operating system of host platform 44, and loads an appropriate software device driver from a storage location in memory 72 into the operating system of host platform 44. During the query, a data table stored in flash memory device 10, which contains configuration information for flash memory device 10 is read from flash memory device 10 into memory 72.

Enforcement of the license of the application program stored on flash memory device 10 may occur during enumeration. The configuration information of flash memory device 10 may include, for example, a location in flash memory module 58 where the application program license information is stored, for example, in application license area 64 or in a license file. Information stored in application license area 64 or the license file may be compared to the unique identifier information stored in serial number area 68. If the software license is authenticated, the application program may be loaded into memory 72 and executed on processor 70. If the application program license is not authenticated, loading of the application program to memory 72 is not allowed and an error message may be generated for output by display 74. Upon completion of the enumeration process, flash memory device 10 is recognized by the operating system of host platform 44 and the application program stored in flash memory module 58, such as stored in application program area 60 may automatically begin loading and executing using host platform 44 or the application program may remain idle until execution is initiated by a user command input. Data stored on flash memory device 10 also may be accessed by application software stored in memory 72 and executed by processor 70.

Enforcement of the application program license may occur during application program execution. The application may be permitted to load into memory 72, for example the memory of processor 70. Processor 70 may then begin execution of the application program. The application program may then authenticate the license using a program code segment of the application program before permitting continued execution of the application program. If the software license is authenticated, the application program may be permitted to continue execution on processor 70. If the application program license is not authenticated, execution of the application program may be terminated, or suspended wherein the user may be prompted to enter an authorization code to continue and an error message may be generated for output to display 74.

In operation, host platform 44 requests services from flash memory device 10 by sending request data packets to USB host controller 54. USB host controller 54 transmits the data packets on USB cable 48. These requests are received by USB flash device controller 56 of flash memory device 10. USB flash device controller 56 then performs various operations such as reading, writing or erasing data from or to flash memory module(s) 58, or supporting basic USB functionality such as device enumeration and configuration. USB flash device controller 56 controls flash memory module(s) 58 by using one or more control lines 76. This includes, for example, controlling the power to flash memory module(s) 58 and using various other signals such as chip enable, and read and write signals controls communication of data to and from flash memory module(s) 58. Flash memory module(s) 58 are also connected to USB flash device controller 56 by an address/data bus 78. Address/data bus 78 transfers commands for performing read, write or erase commands on flash memory module(s) 58, as well as selectively accessing addresses and data as defined, for example, by the manufacturer of flash memory module(s) 58.

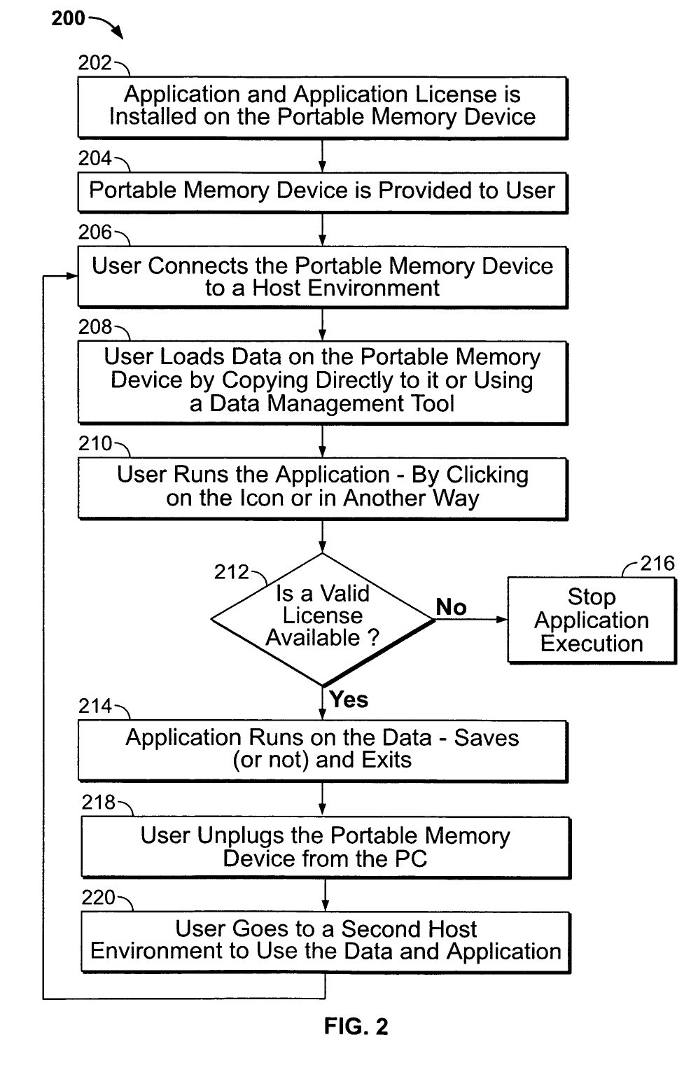

FIG. 2 is a flowchart of an exemplary method 200 of operating flash memory device 10 (shown in FIG. 1). Method 200 includes installing 202 an application program onto application program area 60. In one exemplary embodiment, the application program is downloaded into a portion of a monolithic memory chip. In an alternative embodiment, the application program may be downloaded to one or more of a plurality of individual memory devices communicatively coupled together. In another alternative embodiment, the application program is permanently written, burned into, or otherwise hard-coded into application program area 60. Similarly, the application license corresponding to the application program may be loaded into application license area 64, which may be a portion of a monolithic memory chip or may be embodied in one or more of a plurality of individual memory chips. The application license may be hard-coded into the memory or be downloaded into memory. The application program and the license may be downloaded or installed, for example, at a manufacturing site and then provided 204 to a user pre-loaded and available for use.

Flash memory device 10 may be a proprietary device supplied by the manufacturer or licensor, or may be an off-the-shelf device supplied by a third party such as a vendor. The application program also may be installed by a user, for example by downloading the application program and application license from a network, or another memory media, such as a CD-ROM. Generally, a user receives authorization to download the application program and application license onto flash memory device 10 by purchasing the license rights from the licensor.

The user then couples 206 flash memory device 10 to a first host platform 44, such as a personal computer (PC), or workstation. In the exemplary embodiment, flash memory device 10 includes a universal serial bus (USB) connector and the user couples a USB connector on flash device 10 into a receiving USB connector on first host platform 44. As used herein, USB generally refers to a serial interface or bus technology capable of transferring data at approximately twelve Megabits/second and higher. USB devices may be daisy chained with approximately 127 devices or more on a single port or connection. A host USB connection may provide power from host platform 44 power supply to flash memory device 10. USB also supports hot-plugging such that flash memory device 10 may be coupled to host platform 44 and uncoupled without having to shut down or reboot host platform 44. The user may then transfer 208 data to flash memory device 10 from host platform 44 using a data management tool or by copying or moving files onto flash memory device 10. Data may be transferred to and from flash memory device 10 without enforcement of the application license. When the user begins execution 210 of the application program, for example, by selecting an icon on a virtual desktop of host platform 44, the application may determine whether a valid license for the application program is present on, for example, loaded on flash memory device 10. The application license may be used to determine if a unique identifier, such as a serial number is stored on flash memory device 10. The unique identifier may be located in an unalterable location of memory in flash memory device 10 or may be located remotely from flash memory device 10, such as on dongle 69 that is accessible to host platform 44, or a file located on a network accessible to host platform 44. The program application may query the application license periodically during execution to ensure a valid license.

In one embodiment, the application begins execution before validating the application license, but only allows execution of an application license validation code segment. If the validation code segment cannot validate the application license, the application program may prompt the user for a validation key. If the application program validates the application license using the entered validation key, full execution 214 of the application program is allowed. If a valid license is not provided or located, the application program may remain in an idle state or may terminate execution 216. During execution, application may read data stored in application data area 62 and/or data accessible to host platform 44, operate on the data using instructions in the application program, input from the user, and/or input from host platform 44. The user may exit the application program using a method appropriate to the application program. The user may uncouple 218 flash memory device 10 from host platform 44 and transport 220 flash memory device 10 to a second host platform 44 wherein the user may couple 206 flash memory device 10 to second host platform 44. Method 200 or a portion thereof then may be repeated.

The application program may be, for example, a medical imaging analysis program that receives medical images, for example, but not limited to, positron emission tomography (PET) images, single positron emission computed tomography (SPECT), images, computed tomography (CT) images, magnetic resonance imaging (MRI) images, and ultrasound images. Additionally, the application program may be other types of programs for different applications and uses. Flash memory device 10 allows a doctor, such as a radiologist to view and analyze diagnostic images using a plurality of platforms, for example, computers, without having to predetermine whether a platform to be used includes a licensed copy of the application program and/or the necessary data installed on it. The doctor may simply transport the application program, the data, and the application license on flash memory device 10 to any platform capable of communicating via a USB protocol and execute the program on flash memory device 10 using the platform to access the data stored thereon.

A technical effect of the above described flash memory device and methods provides improved portability, cost, and performance for application programs that may be used in a plurality of locations, for example, locations remote from the source of the data, wherein at least some of the remote locations may not be equipped with the application program or the application license.

The above-described embodiments of a flash memory device and methods are cost-effective and highly reliable for facilitating portability of application programs due to the relatively small size of the flash memory device and the need for only a single license to operate the application program in multiple locations at the convenience of the user while maintaining the intellectual property rights of the application program developer. Accordingly, incorporating the program application, application data and application license into a single device capable of plug-and-play portability facilitates, for example, medical diagnostic imaging analysis and diagnosis in a cost-effective and reliable manner.

Although exemplary embodiments of flash memory device components are described above in detail, the components are not limited to the specific embodiments described herein, but rather, components of each system may be utilized independently and separately from other components described herein. Each flash memory device component also may be used in combination with other flash memory device components.

While the invention has been described in terms of various specific embodiments, those skilled in the art will recognize that the invention can be practiced with modification within the spirit and scope of the claims.

1. A method of executing an application program resident on a portable memory device, said method comprising:
providing a portable memory device having at least one application program stored thereon;
determining whether a valid license corresponds to the application program, the application license residing at least one of, at least partially, on the portable memory device, and in a memory accessible to a portable memory device host platform; and
executing the application program from the portable memory device using a host platform processor if the presence of a valid license is determined.

2. A method in accordance with claim 1 wherein the application program comprises a medical imaging application program, said method further comprising storing medical image data on the portable memory device.

3. A method in accordance with claim 2 wherein storing medical image data on the portable memory device comprises storing positron emission tomography image data on the portable memory device.

4. A method in accordance with claim 1 further comprising communicating with the portable memory device from a host platform using a serial bus connection.

5. A method in accordance with claim 1 further comprising coupling the portable memory device to a host platform using a universal serial bus (USB) connection.

6. A method in accordance with claim 1 wherein determining whether a valid license corresponds to the application program comprises:
determining a unique identifier for the portable memory device;
comparing the unique identifier to a license file residing on the portable memory device; and
generating a signal indicative of a valid license based on the comparison.

7. A method in accordance with claim 6 wherein determining a unique identifier for the portable memory device comprises determining a unique identifier for the portable memory device from a serial number hard coded into the portable memory device.

8. A method in accordance with claim 6 wherein determining a unique identifier for the portable memory device comprises determining a unique identifier for the portable memory device from a file accessible through a network.

9. A method in accordance with claim 1 wherein determining whether a valid license corresponds to the application program comprises:
querying a dongle, including a unique identifier, coupled to the host computer;
comparing the unique identifier to a license file residing on the portable memory device; and
generating a signal indicative of a valid license based on the comparison.

10. A method in accordance with claim 9 wherein querying a dongle comprises periodically querying the dongle while the application program is executing.

11. A method in accordance with claim 1 further comprising downloading at least one data file directly from the host computer to a data memory portion of the portable memory device.

12. A method in accordance with claim 1 further comprising writing at least one data file directly from the application program to a data memory portion of the portable memory device.

13. A method in accordance with claim 1 further comprising:
uncoupling the portable memory device from the host computer;
coupling the portable memory device to a second host computer;
executing the program application from the portable memory device using the second host computer; and
reading data into the program application from at least one of a data memory potion of the portable memory device and the host computer.

14-27. (canceled)
